(19) United States
(12) Patent Application Publication
(10) Pub. No.: US 2009/0314869 A1
(43) Pub. Date: Dec. 24, 2009

(54) DRUM FOR COUNTERBALANCING SYSTEM OF A CABLE-OPERATED DOOR

(75) Inventors: Normand Savard, Drummondville (CA); Yannick Funk, Drummondville (CA); Philippe Larochelle, Drummondville (CA)

Correspondence Address: MERCHANT & GOULD PC, P.O. BOX 2903, MINNEAPOLIS, MN, 55402-0903, US

(73) Assignee: CANIMEX INC., Drummondville (CA)

(21) Appl. No.: 12/415,920

(22) Filed: Mar. 31, 2009

Related U.S. Application Data
(60) Provisional application No. 61/064,865, filed on Mar. 31, 2008.

(51) Int. Cl. B65H 75/28; E06B 7/00; E06B 3/00

(52) U.S. Cl. 242/125.1; 49/70; 49/506

(57) ABSTRACT

A drum which receives a cable of a counterbalancing system of a cable-operated door, the cable having an extremity provided with a stopper. The drum includes a substantially cylindrical body, a cable entry groove and a securing slot. The drum further includes an embossment configured about the drum and its components in order to prevent that the cable from coming off its normal position in the drum when there is a “slack” condition in the cable.

This application claims benefit of U.S. Ser. No. 60/064,865, filed Mar. 31, 2008 in the United States and which application is incorporated herein by reference. To the extent appropriate, a claim of priority is made to the above disclosed application.

### FIELD OF THE INVENTION

The present invention relates to a drum. More particularly, and in its preferred intended use, the present invention relates to a drum for receiving a cable of a counterbalancing system of a cable-operated door.

### BACKGROUND OF THE INVENTION

Garage doors and the like are well known in the art. Indeed, most garage doors usually require to be provided with a counterbalancing system for counterbalancing the weight of the door in order to decrease the force required to open the door and also safely facilitate its closing from a raised to a lowered position. Counterbalancing systems can be found in many other types of cable-operated doors, such as slidable truck doors, trailer doors and the like, for example.

It is also known in the art that a widely used type of counterbalancing system generally comprises a pair of spaced apart cable drums connected to corresponding cables, each cable being in turn connected to a lower opposite side edge of the garage door. The cable drums are usually mounted on an overhead shaft which is typically supported above the door opening and is connected to one or more torsion springs which are each fixed to the shaft at one end, and operatively secured to a fixed structure such as the wall, or a wall bracket, for example, at the other end, so that the cable drums are biased to rotate in a direction which winds the cables onto the drums and counteracts the weight of the door connected to the cables. The torsion springs are adjusted to properly balance the weight of the door so that minimal opening and closing efforts are required, either manually or when motor controlled.

It is also known in the art that conventional, low cost adjustment devices used for the above-mentioned type of counterbalancing system, and widely utilized in the garage door industry, are generally cylindrical “anchors” commonly referred to also as “plugs” (“collars”, “cones”, etc.) which are connected to the ends of the torsion springs and are thus mounted on the aforementioned shaft for adjusting the deflection of the springs to preset the torsional (or counterbalancing) force of the spring.

In operation, torque is transferred between the torsion spring, overhead shaft, and anchors (or “plugs”), which operatively connect the shaft to the spring, in order to counterbalance the weight of the garage door. Usually, each torsion spring is fixed to the overhead shaft at one end, by means of a plug known as a “winding plug”, and operatively secured to the wall via a bracket at the other end, by means of another plug known as a “stationary plug”.

Large, vertical opening door assemblies, such as commercial and residential sectional garage doors, also usually require mechanisms to counterbalance the weight of the door in order to minimize door opening efforts and to control movement of the door from an opened to a closed position. Large sectional garage doors for commercial and residential applications may be manually or power operated. In either case, but particularly for manual operation, counterbalancing mechanisms have been used for many years to counterbalance the weight of the door and control its opening and closing movements so that one person can easily control operation of the door. Counterbalancing mechanisms are also advantageous for power operated vertical opening doors since they reduce motor power requirements and the required strength of the door opening and closing mechanism. In other words, lighter weight, lower cost, door control mechanisms may be used if a counterbalancing mechanism is connected to the door to assist the opening and closing actions.

The Assignee of the present application has developed several devices to be used with door assemblies and the like, several of which are described in the following US patents and patent applications: U.S. Pat. Nos. 6,174,575 B1; 6,279,268 B1; 6,378,170 B1; 6,485,006 B1; 6,502,281 B2; 6,681,809 B2; 6,694,673 B2; 6,712,116 B2; 6,907,964 B2; 6,931,810 B2; 6,959,751 B2; 6,986,378 B2; 6,988,527 B2; 7,000,292 B2; 7,000,354 B2; 7,086,441 B2; 7,350,333 B2; 7,441,749 B2; D490,685 S; D520,338 S; D524,633 S; 2002/0117787 A1; 2003/0024658 A1; 2003/0115928 A1; 2003/0198790 A1; 2003/0221801 A1; 2003/0230389 A1; 2004/0000109 A1; 2004/0003554 A1; 2004/0020609 A1; 2004/0089097 A1; 2004/0103505 A1; 2004/0124050 A1; 2004/0182007 A1; 2005/0006545 A1; 2005/0183341 A1; 2006/0185800 A1; 2007/0012410 A1; 2007/0084012 A1; 2007/0145339 A1; 2007/0204515 A1; 2007/0283525 A1; and US-2008/0023603 A1.

It is also known in the art that common cable attach systems used with conventional drums of counterbalancing systems employed in the garage door industry do not enable to mechanically block a given cable end to the drum, and as a result thereof, in the event of a slack in said given cable, a situation may occur (although generally unlikely), under particular given circumstances, where this may cause the counterbalancing system of the door not to be properly functional. This is particularly true and is particularly frequent in counterbalancing systems used in the trailer industry. Thus, it would be very useful to provide a modified cable or a corresponding drum which would enable to overcome the aforementioned problem.

Hence, in light of the above-discussed, there is a need for an improved device which, by virtue of its design and components, would be able to overcome or at least minimize some of the aforementioned prior art problems.

### SUMMARY OF THE INVENTION

The object of the present invention is to provide a device, which by virtue of its design and components, satisfies some of the above-mentioned needs and is thus an improvement over other related devices and/or methods known in the prior art.

In accordance with the present invention, the above object is achieved, as will be easily understood, with a drum, such as the one briefly described herein, and such as the one exemplified in the accompanying drawings.

More particularly, according to the present invention, there is provided a drum for receiving a cable of a counterbalancing system of a cable-operated door, said cable having an extremity provided with a stopper, the drum comprising:

a substantially cylindrical body having first and second sides, the body including an inner bore for mounting the body about a shaft of the counterbalancing system, the body being provided a peripheral surface area defined between the first and second sides, and about which is woundable a portion of the cable;

a cable entry groove for receiving therein an end segment of the cable, the cable entry groove being defined between first and second flanges provided along a rim of a given side of the body, the cable entry groove extending substantially between the peripheral area of the body and respective bottom portions of the flanges; and

a securing slot, provided adjacent to the cable entry groove, for securing therein a segment of the cable when the drum is operated in a working configuration within the counterbalancing system, the securing slot being defined by the second flange and extending substantially between the peripheral area of the body and respective bottom portions of the flanges, the securing slot being provided with a pair of shoulders for abutting against the stopper of the cable;

the improvement wherein a bottom portion of the first flange comprises an embossment extending beyond a bottom portion of the second flange for abutting with the stopper of the cable in the event of a slack condition in the cable so as to prevent the segment of the cable from coming out of the cable entry groove.

Preferably, the embossment of the first flange comprises a first substantially straight portion extending downwardly past the bottom portion of the second flange. Preferably also, the embossment of the first flange comprises a second substantially slanted portion extending rearwardly away from the bottom portion of the second flange.

Preferably, the peripheral surface area of the body comprises at least one peripheral groove for receiving the portion of the cable wound about said peripheral surface area of the body. Preferably also, the at least one peripheral groove is operatively connected to the cable entry groove. Preferably also, the peripheral surface area of the body comprises a transition zone between an end of the at least one peripheral groove and the cable entry groove. Preferably also, the transition zone is rounded.

Preferably, the inner bore is defined within a hub of the body, and the hub comprises at least one threaded hole for receiving a corresponding fastener insertable therein for securing the body of the drum about the shaft of the counterbalancing system. Preferably also, the fastener is a setscrew. Preferably also, the hub comprises a pair of threaded holes and a pair of corresponding setscrews.

Preferably also, the body comprises reinforcement ribs operatively extending between the hub and the peripheral surface area of the body.

Preferably also, components of the drum are made out of one piece and out of one material.

According to another aspect of the present invention, there is also provided a method of blocking a cable of a counterbalancing system of a cable-operated door onto a drum such as the one described herein, said cable having an extremity provided with a stopper, the method comprising the steps of:
a) mounting the drum onto a shaft of the counterbalancing system;
b) sliding an end segment of the cable into the cable entry groove;
c) securing a segment of the cable into the securing slot;
d) operating the drum in a working configuration within the counterbalancing system; and
e) abutting the stopper of the cable with the embossment of the first flange of the drum in the event of a slack condition in the cable so as to prevent the segment of the cable from coming out of the cable entry groove.

According to yet another aspect of the present invention, there is also provided a blocking cable having an extremity provided with a stopper for use with the above-mentioned drum and/or method.

According to yet another aspect of the present invention, there is also provided a door assembly (e.g. a garage door, or other cable-operated door, etc.) assembled with the above-mentioned blocking cable and/or drum.

According to yet another aspect of the present invention, there is also provided a kit with components for assembling the above-mentioned blocking cable, drum and/or door assembly.

According to yet another aspect of the present invention, there is also provided a method of assembling components of the above-mentioned kit and/or door assembly.

According to yet another aspect of the present invention, there is also provided a method of packaging the above-mentioned kit and/or door assembly.

The objects, advantages and other features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a perspective view of a garage door provided with a counterbalancing system according to the prior art.

FIGS. 2a and 2b are respectively front and rear views of a drum according to the prior art.

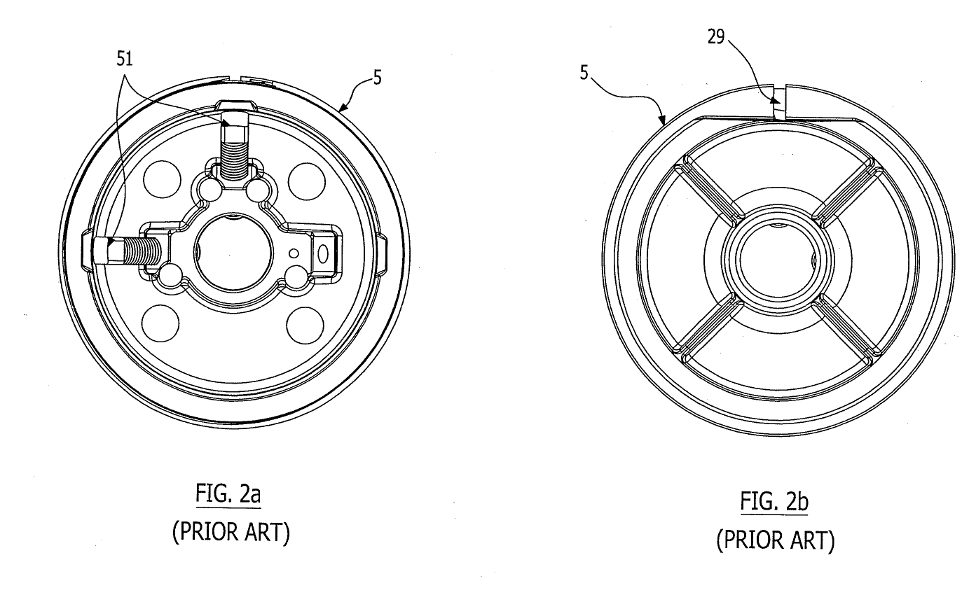

FIG. 3 is a rear view of a drum cooperating with a cable according to the prior art.

FIGS. 4a and 4b are respectively front and rear views of a modified drum according to a preferred embodiment of the present invention.

FIG. 5 is another rear view of a drum cooperating with a blocking cable according to yet another preferred embodiment of the present invention.

FIG. 6 is an enlarged view of a portion of what is shown in FIG. 5.

FIG. 7 is a rear perspective view of a drum according to the prior art.

FIG. 8 is a rear perspective view of a drum according to another preferred embodiment of the present invention.

FIG. 9 is a front perspective view of a drum according to yet another preferred embodiment of the present invention.

FIG. 10 is a front perspective view of a drum according to yet another preferred embodiment of the present invention.

FIG. 11 is a side perspective view of the drum shown in FIG. 8.

FIG. 12 is an enlarged perspective view of a portion of the drum shown in FIG. 8.

### DETAILED DESCRIPTION OF PREFERRED EMBODIMENTS OF THE INVENTION

In the following description, the same numerical references refer to similar elements. The embodiments, geometrical configurations, materials mentioned and/or dimensions shown in the figures or described in the present description are preferred embodiments only, given for exemplification purposes only.

In the context of the present description, the expression “garage door” includes all types of cable-operated or sectional doors and the like, including access openings, slidable truck doors, trailer doors, etc., which may or may not require the use of at least one torsion spring for counterbalancing the weight of the given door. Although the present invention was primarily designed for a sectional garage door, it may be used with other kinds of doors, or with any other items using a counterbalancing system, as apparent to a person skilled in the art. For this reason, the expression “garage door” or “sectional” should not be taken as to limit the scope of the present invention and includes all other kinds of doors or items with which the present invention may be used and could be useful, as also apparent to a person skilled in the art.

Moreover, in the context of the present description, the expressions “garage”, “door” and “assembly”, “drum”, “cable” and “device”, “counterbalancing shaft” and “overhead shaft”, “counterbalancing mechanism” and “counterbalancing system”, “counterbalancing”, “driving” and “raising”, as well as any other equivalent expressions and/or compound words thereof, may be used interchangeably. The same applies for any other mutually equivalent expressions, such as “receiving”, “cooperating”, “blocking” and “securing” for example, as well as “device” and “assembly”, or even “cable”, “stopper” and “button”, as apparent to a person skilled in the art.

In addition, although the preferred embodiment of the present invention as illustrated in the accompanying drawings comprises various components, etc., and although the preferred embodiment of the blocking cable 23, drum 21 and corresponding parts of the present invention as shown consists of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for the blocking cable 23 and drum 21 according to the present invention, as will be briefly explained herein and as can be easily inferred herefrom by a person skilled in the art, without departing from the scope of the invention.

Broadly described, the blocking cable 23, and corresponding modified drum 21, to be used within a counterbalancing system, as exemplified in the accompanying drawings, has been developed to assure that the given cable 23 will not slip away from its normal position in the drum 21 when operating within the counterbalancing system, particularly and preferably in situations where there is a reduced operational weight of the moving door (i.e. “slack” condition), such as in the garage door industry or in the trailer industry, for example. It is worth mentioning however that the present invention is not necessarily limited to such doors, nor to the presence of a torsional spring in the door system, as can be easily understood by a person skilled in the art, in view of the present description.

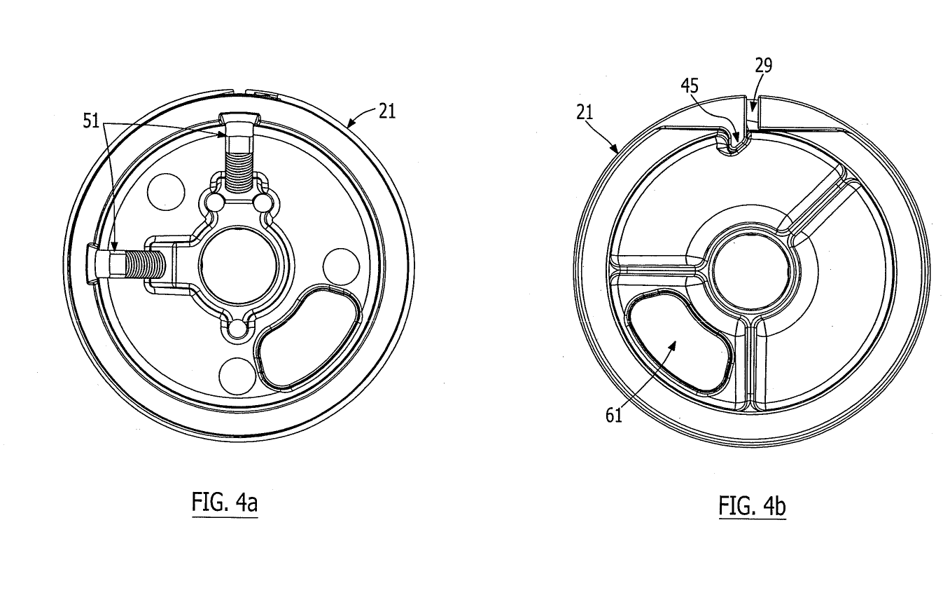

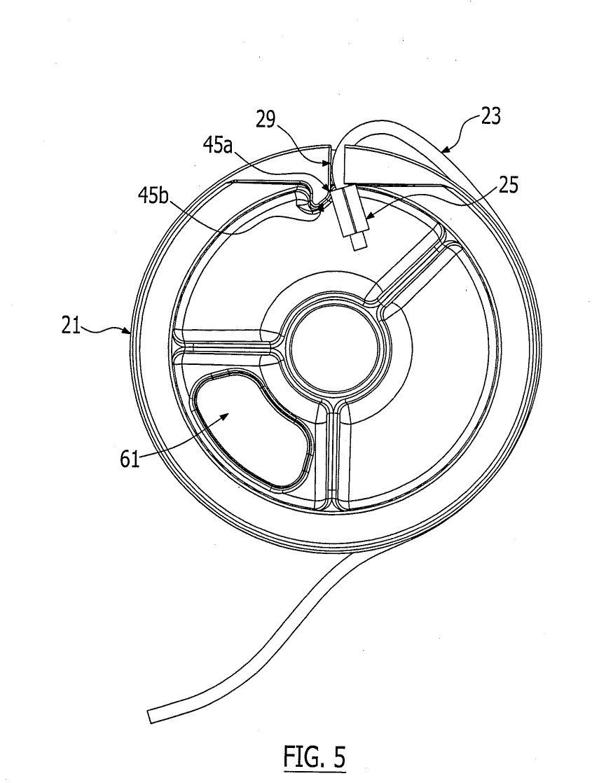

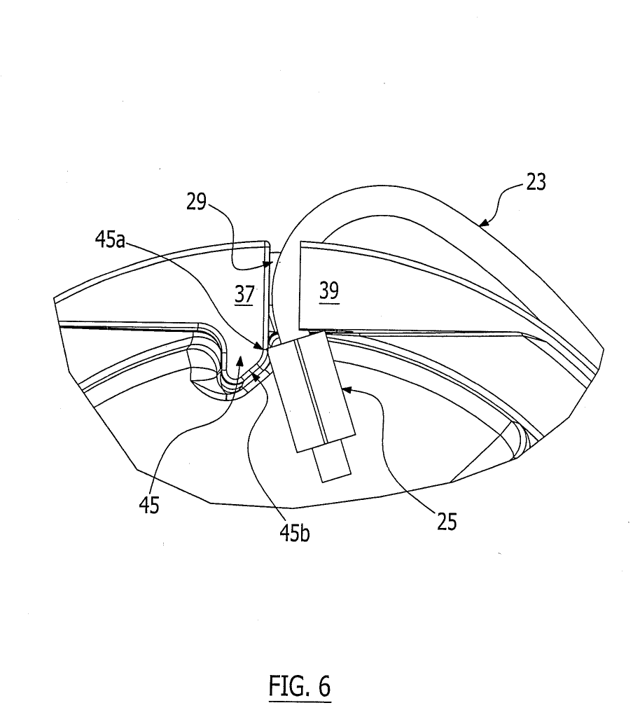

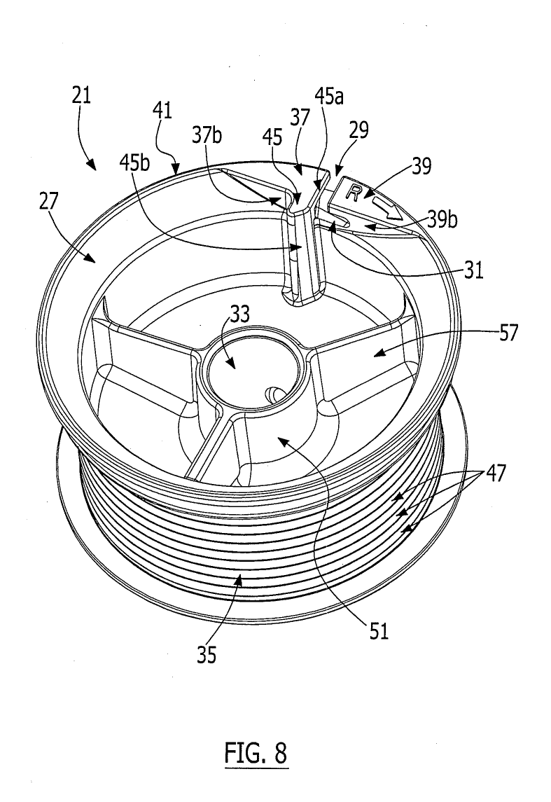

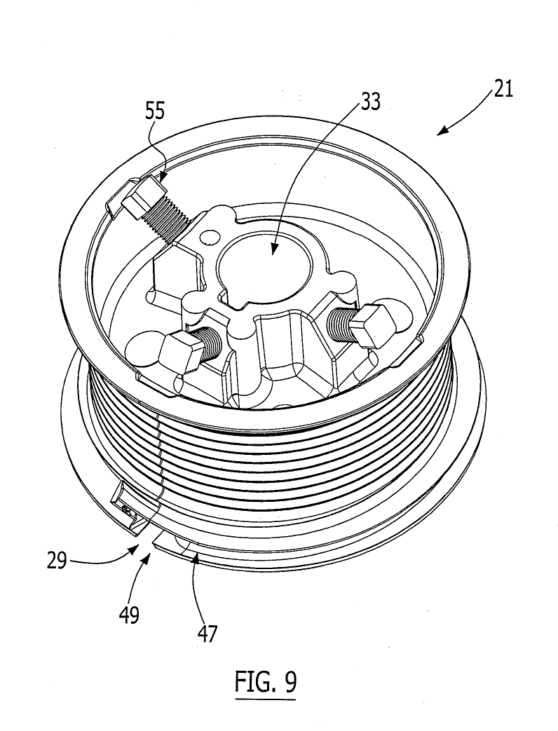

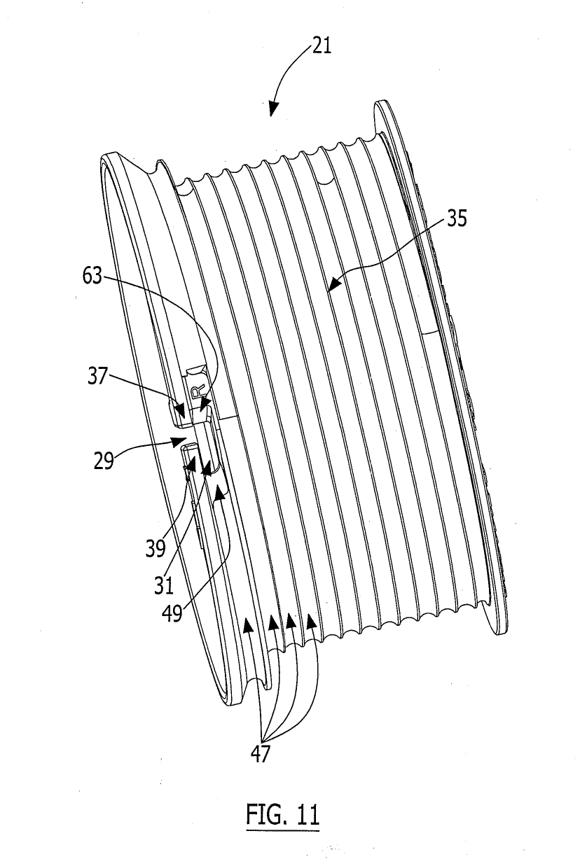

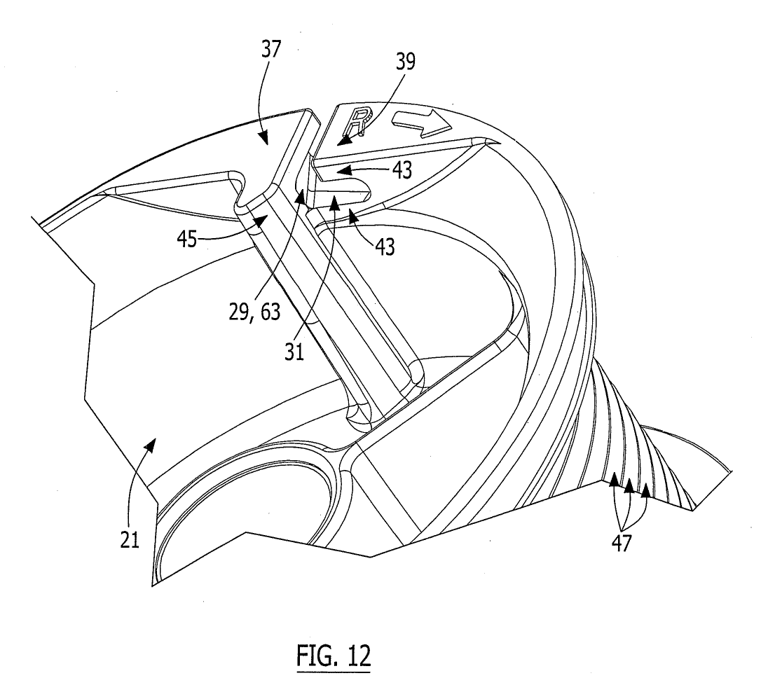

More particularly, according to the present invention, and as better shown in FIGS. 4 and 5, there is provided a drum 21 for receiving a cable 23 of a counterbalancing system of a cable-operated door, said cable 23 having an extremity provided with a stopper 25, the drum 21 comprising a substantially cylindrical body 27, a cable entry groove 29 and securing slot 31. As can be easily understood when referring to FIGS. 8-12, the body 27 has first and second sides, and includes an inner bore 33 for mounting the body about a shaft of the counterbalancing system, the body being provided a peripheral surface area 35 defined between the first and second sides, and about which is woundable a portion of the cable 23. As better shown in FIGS. 5 and 6, cable entry groove 29 is used for receiving therein an end segment of the cable 23, and is defined between first and second flanges 37, 39, provided along a rim 41 of a given side of the body 27, the cable entry groove 29 extending substantially between the peripheral area of the body and respective bottom portions 37b, 39b of the flanges 37, 39. As can be easily understood when referring to FIGS. 11 and 12, securing slot 31, preferably provided adjacent to the cable entry groove 29, is used for securing therein a segment of the cable 23 when the drum 21 is operated in a working configuration within the counterbalancing system, the securing slot 31 being defined by the second flange and extending substantially between the peripheral surface area 35 of the body 27 and respective bottom portions 37b, 39b of the flanges 37, 39, the securing slot 31 being provided with a pair of shoulders 43 for abutting against the stopper 25 of the cable 23. It is worth mentioning that cable entry groove 29 and adjacent slot 31 may be considered as a common groove/slot to the drum 21, as apparent to a person skilled in the art.

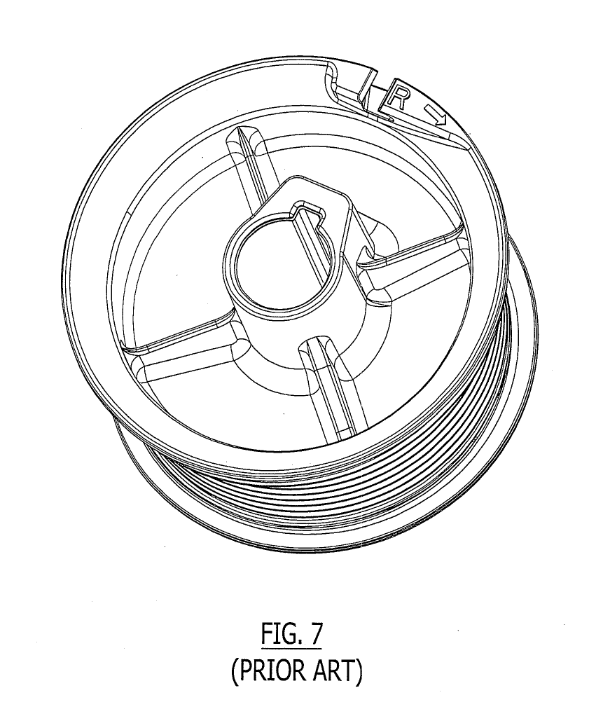

As can be easily understood when contrasting FIGS. 7 and 8 for example, an important improvement of the present invention resides in that a bottom portion 37b of the first flange 37 comprises an embossment 45 extending beyond a bottom portion 39b of the second flange 39 for abutting with the stopper 25 of the cable 23 in the event of a slack condition in the cable 23 so as to prevent the segment of the cable 23 from coming out of the cable entry groove 29, something that is not possible with the conventional plug of FIG. 7.

According to a preferred aspect of the present invention, the embossment 45 of the first flange 37 comprises a first substantially straight portion 45a extending downwardly past the bottom portion 39b of the second flange 39. This is particularly advantageous in that it assures that the cable 23 is maintained in place during the operation of the drum 21 within the counterbalancing system, even in the event of a “slack” condition in the cable 23, so as to prevent the segment of the cable 23 from coming out of the cable entry groove 29. Preferably also, the embossment 45 of the first flange 37 comprises a second substantially slanted portion 45b extending rearwardly away from the bottom portion 39b of the second flange 39. This is also particularly advantageous in that, in complement to the aforementioned straight portion 45a, this other component and feature of the present invention enables to bring back the stopper 25 of the cable 23 in place towards the straight portion 45a and thus further preventing the extremity of the cable 23 from coming off/out the drum 21.

As better shown in FIGS. 8-12, the peripheral surface area 35 of the body 27 preferably comprises at least one peripheral groove 47 for receiving the portion of the cable 23 wound about said peripheral surface area 35 of the body 27. Preferably also, the at least one peripheral groove 47 is operatively connected to the cable entry groove 29, as better shown in FIG. 11. Preferably also, the peripheral surface area 35 of the body 27 comprises a transition zone 49 between an end of the at least one peripheral groove 47 and the cable entry groove 29, and this transition zone 49 is preferably rounded. Preferably also, and as better shown in FIGS. 11 and 12, the cable entry groove 29 comprises a tapered portion 63, for better receiving a corresponding portion of the cable 23 cooperating with the drum 21, during a given operating configuration, for an improved performance of the system. It is worth mentioning however that the transition zone 49, tapered portion 63 and/or other neighboring components, such as the peripheral grooves 47, may be shaped and configured otherwise, whether alone and/or with respect to one another, depending on the particular applications and the desired end results intended for the present drum 21, as can be easily understood by a person skilled in the art.

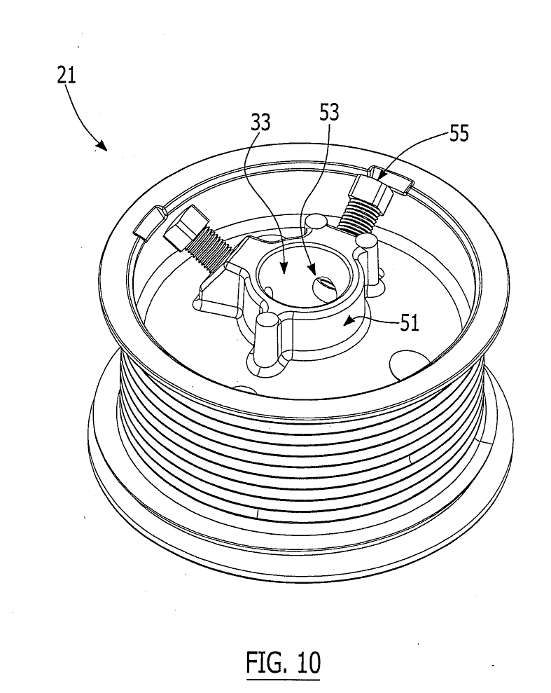

Preferably, the inner bore 33 is defined within a hub 51 of the body 27, and the hub 51 comprises at least one threaded hole 53 for receiving a corresponding fastener 55 insertable therein for securing the body 27 of the drum 21 about the shaft of the counterbalancing system. Preferably also, the fastener 55 is a setscrew. Preferably also, the hub 51 comprises a plurality of threaded holes 53 and corresponding setscrews, such as a pair of threaded holes 53 and a pair of corresponding setscrews, as exemplified in FIG. 10.

Preferably also, the body 27 comprises reinforcement ribs 57 operatively extending between the hub 51 and the peripheral surface area 35 of the body 27, so as to provide structural reinforcement to the drum 21. Preferably also, components of the drum are made out of one single piece and out of one single material, according to a suitable manufacturing and cost effective process.

According to another aspect of the present invention, there is also provided a method of blocking a cable 23 of a counterbalancing system of a cable-operated door onto a drum 21 such as the one described herein, said cable 23 having an extremity provided with a stopper 25, the method comprising the steps of: a) mounting the drum 21 onto a shaft of the counterbalancing system; b) sliding an end segment of the cable 23 into the cable entry groove 29; c) securing a segment of the cable 23 into the securing slot 31; d) operating the drum 21 in a working configuration within the counterbalancing system; and e) abutting the stopper 25 of the cable 23 with the embossment 45 of the first flange 37 of the drum 21 in the event of a slack condition in the cable 23 so as to prevent the segment of the cable 23 from coming out of the cable entry groove 29.

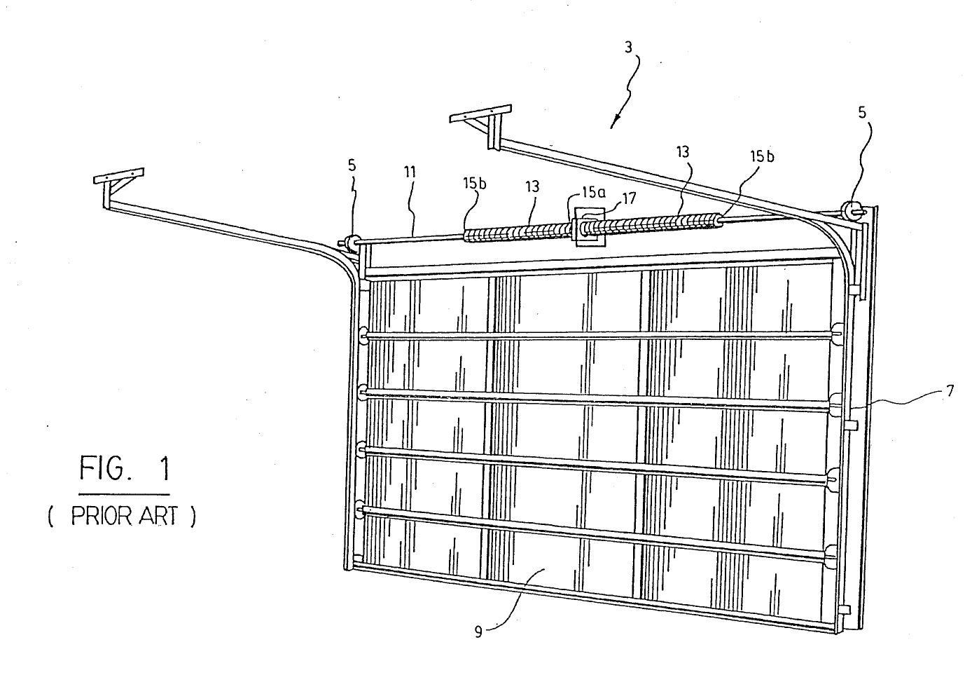

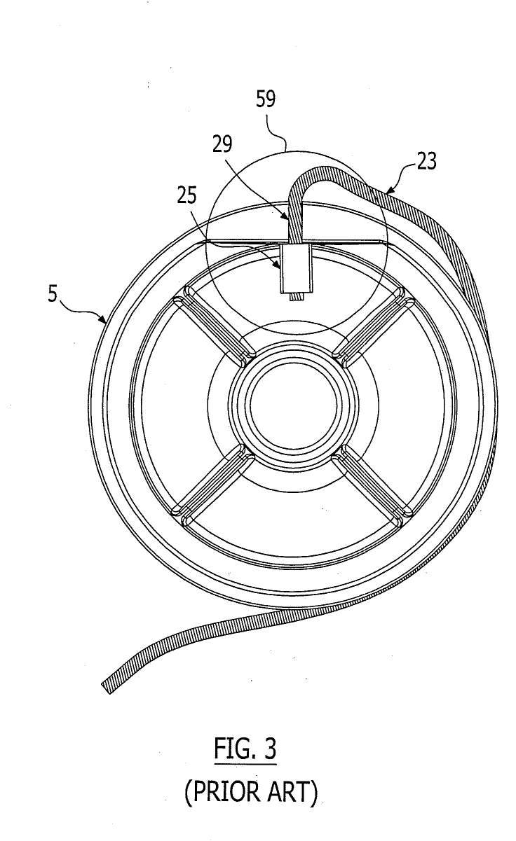

As previously explained, doors for trailers or garage doors need to be counterbalanced in order to reduce the force required by the user in normal operation. FIG. 1 shows a closed door. In this position, cables 7 are unwrapped from the drum 5. When the door 9 opens, cables 7 wrap around the drums 5. As the door 9 raises, springs 13 release their torque as door weight 9 reduces. In the closed position, as shown in FIG. 1, cables 7 are extended to their maximum. In some circumstances, for an exceedingly fast movement or for a non proper cable length, cables 7 might become slack as shown in FIG. 3. In such an event, cable end segment 59, in the drum cable entry 29, might become slack, go forward, and/or even come out of cable slot 29. If this happens, cable 23 become “useless” and door may become non functional.

In order to avoid this cable slippage, the present invention proposes an embossment 45 built on the drum 21 under cable entry groove 29, as better shown in FIG. 5. The shape of this embossment 45 preferably includes two main features, better shown in FIG. 6, namely: a) a surface angle shape 45b to force cable 23 to enter in the right position when cable 23 is under tension; and b) a flat surface 45a to force cable 23 stop bottom 25 into cable entry groove 29.

At the installation, cable 23 is preferably inserted into the cable groove 29 and then tension is applied manually on the drum 21 to force the stop button 25 to its proper place by sliding against the angle surface embossment 45b. To force the stop button in place, a “stretching hole” 61 is preferably added to the drum 21 to help installer to pull on the drum 21 and induce a rotation to force stop button 25 in place at the embossment bottom, then installer may screw fasteners 55 (e.g. two setscrews) against the shaft 11 in order to maintain tension on the cable 23.

In normal operation, cable 23 is held in the drum cable entry 29 by tension generated in the cable 23 by the torque generated by the spring, this tension is meant to be always positive. In the case where tension becomes negative (e.g. slack in the cable), embossment 45 acts on stop button 25 by limiting its movement and keeping cable 23 in place, eliminating, or at the very least substantially reducing, a risk of cable slippage, as can be easily understood by a person skilled in the art, in view of the present description and when referring to the accompanying drawings.

It is worth mentioning that several modifications could be made to the above-described drum 21 and corresponding blocking cable 23, without departing from the scope of the present invention. Indeed, there are many ways to modify the present invention in order to reach the same goal, as can be easily understood by a person skilled in the art. For example, angle 45b might be removed or its general shape may be modified, for example, by adding a reverse angle to become more “proactive” in maintaining a stop button 25 in place, as can be easily understood by a person skilled in the art. Moreover, stretching hole 61 might also have different shapes or configurations, and may be replaced by another embossment to reach the same functionality, as can also be easily understood by a person skilled in the art.

Furthermore, the drum 21 shown in the accompanying figures is a “right” drum 21 to be located at the top right portion of the garage door, more specifically at the right-hand side thereof when viewed from the inside of the garage. A “left” drum 21, that is, a left-hand side version of the drum 21 shown, would simply be a mirror image of what is in the accompanying figures.

Moreover, according to the present invention, the blocking cable 23, drum 21 and corresponding parts are preferably made of substantially rigid materials, such as metallic materials (steel, etc.), hardened polymers, composite materials, and/or the like, depending on the particular applications for which the assembly is intended for and the different parameters in cause (counterbalancing force in the spring, weight of the door, etc.), as apparent to a person skilled in the art.

As being now better appreciated, the present invention is an improvement and presents several advantages over other related devices and/or methods known in the prior art. Indeed, the present invention offers structural and functional features to prevent cable slippage from its normal position in drum 21 for certain circumstances, as briefly explained hereinabove.

Of course, numerous modifications could be made to the above-described embodiments without departing from the scope of the invention, as defined in the appended claims.

1. A drum for receiving a cable of a counterbalancing system of a cable-operated door, said cable having an extremity provided with a stopper, the drum comprising:
a substantially cylindrical body having first and second sides, the body including an inner bore for mounting the body about a shaft of the counterbalancing system, the body being provided a peripheral surface area defined between the first and second sides, and about which is woundable a portion of the cable;
a cable entry groove for receiving therein an end segment of the cable, the cable entry groove being defined between first and second flanges provided along a rim of a given side of the body, the cable entry groove extending substantially between the peripheral area of the body and respective bottom portions of the flanges; and
a securing slot, provided adjacent to the cable entry groove, for securing therein a segment of the cable when the drum is operated in a working configuration within the counterbalancing system, the securing slot being defined by the second flange and extending substantially between the peripheral area of the body and respective bottom portions of the flanges, the securing slot being provided with a pair of shoulders for abutting against the stopper of the cable;
the improvement wherein a bottom portion of the first flange comprises an embossment extending beyond a bottom portion of the second flange for abutting with the stopper of the cable in the event of a slack condition in the cable so as to prevent the segment of the cable from coming out of the cable entry groove.

2. A drum according to claim 1, wherein the embossment of the first flange comprises a first substantially straight portion extending downwardly past the bottom portion of the second flange.

3. A drum according to claim 2, wherein the embossment of the first flange comprises a second substantially slanted portion extending rearwardly away from the bottom portion of the second flange.

4. A drum according to claim 1, wherein the peripheral surface area of the body comprises at least one peripheral groove for receiving the portion of the cable wound about said peripheral surface area of the body.

5. A drum according to claim 4, wherein the at least one peripheral groove is operatively connected to the cable entry groove.

6. A drum according to claim 6, wherein the peripheral surface area of the body comprises a transition zone between an end of the at least one peripheral groove and the cable entry groove.

7. A drum according to claim 7, wherein the transition zone is rounded.

8. A drum according to claim 1, wherein the cable entry groove comprises a tapered portion for receiving a corresponding portion of the cable cooperating with the drum during a given operating configuration.

9. A drum according to claim 1, wherein the inner bore is defined within a hub of the body, and the hub comprises at least one threaded hole for receiving a corresponding fastener insertable therein for securing the body of the drum about the shaft of the counterbalancing system.

10. A drum according to claim 9, wherein the fastener is a setscrew.

11. A drum according to claim 10, wherein the hub comprises a pair of threaded holes and a pair of corresponding setscrews.

12. A drum according to claim 9, wherein the body comprises reinforcement ribs operatively extending between the hub and the peripheral surface area of the body.

13. A drum according to claim 1, wherein components of the drum are made out of one piece and out of one material.

14. A drum according to claim 1, wherein the embossment of the first flange comprises a first substantially straight portion extending downwardly past the bottom portion of the second flange; wherein the embossment of the first flange comprises a second substantially slanted portion extending rearwardly away from the bottom portion of the second flange; wherein the peripheral surface area of the body comprises at least one peripheral groove for receiving the portion of the cable wound about said peripheral surface area of the body; wherein the at least one peripheral groove is operatively connected to the cable entry groove; wherein the peripheral surface area of the body comprises a transition zone between an end of the at least one peripheral groove and the cable entry groove; wherein the transition zone is rounded; wherein the cable entry groove comprises a tapered portion for receiving a corresponding portion of the cable cooperating with the drum during a given operating configuration; wherein the inner bore is defined within a hub of the body, and the hub comprises at least one threaded hole for receiving a corresponding fastener insertable therein for securing the body of the drum about the shaft of the counterbalancing system; wherein the fastener is a setscrew; wherein the hub comprises a pair of threaded holes and a pair of corresponding setscrews; wherein the body comprises reinforcement ribs operatively extending between the hub and the peripheral surface area of the body; and wherein components of the drum are made out of one piece and out of one material.

15. A counterbalancing system comprising at least one drum according to claim 1.

16. A cable-operated door comprising at least one drum according to claim 1.

17. A door assembly comprising at least one drum according to claim 1.

18. A method of blocking a cable of a counterbalancing system of a cable-operated door onto a drum, said cable having an extremity provided with a stopper, the method comprising the steps of:
f) mounting the drum onto a shaft of the counterbalancing system;
g) sliding an end segment of the cable into the cable entry groove;
h) securing a segment of the cable into the securing slot;
i) operating the drum in a working configuration within the counterbalancing system; and
j) abutting the stopper of the cable with the embossment of the first flange of the drum in the event of a slack condition in the cable so as to prevent the segment of the cable from coming out of the cable entry groove.
